(19) United States
(12) Patent Application Publication
(10) Pub. No.: US 2025/0200436 A1
(43) Pub. Date: Jun. 19, 2025

(54) SECURE GLOBAL MODEL CALCULATION APPARATUS, SECURE GLOBAL MODEL CALCULATION SYSTEM CONFIGURING METHOD, AND PROGRAM

(71) Applicant: NIPPON TELEGRAPH AND TELEPHONE CORPORATION, Tokyo (JP)

(72) Inventors: Iifan TYOU, Tokyo (JP); Gembu MOROHASHI, Tokyo (JP); Takumi FUKAMI, Tokyo (JP)

(73) Assignee: NIPPON TELEGRAPH AND TELEPHONE CORPORATION, Tokyo (JP)

(21) Appl. No.: 18/849,668

(22) PCT Filed: Mar. 31, 2022
(86) PCT No.: PCT/JP2022/016503

§ 371 Date: Sep. 23, 2024

(51) Int. Cl. G06N 20/00

(52) U.S. Cl. CPC G06N 20/00

(57) ABSTRACT

A technique for efficiently training a model by providing a function of training a local model by a device constituting a secure computation system for computing a global model in a federated learning. Arbitrary N secure global model computation devices among K secure global model computation devices can constitute a secure global model computation system for performing secure computation of a global model from N local models, wherein K is an integer of 3 or more and N is an integer satisfying 3≤N≤K, and a secure global model computation device includes a selection unit that selects N−1 secure global model computation devices having a large availability of computation resources from K−1secure global model computation devices excluding the secure global model computation device itself, and a system configuration unit that configures a secure global model computation system using N secure global model computation devices obtained by combining the selected N−1 secure global model computation devices and the secure global model computation device itself.

### TECHNICAL FIELD

The present invention relates to a federated learning technique, and more particularly, to a technique for efficiently training a model by providing a function of training a local model by a device constituting a secure computation system for computing a global model.

### BACKGROUND ART

As a technique for performing learning without aggregating training data into one device, there is a federated learning technique. As a federated learning technique, there is FedAVG described in NPL 1, for example.

FIG. 1 is a diagram showing a basic configuration of a federated learning system. The federated learning system 90 includes M (M is an integer of 2 or more) local model training devices 700₁, . . . , 700_{M} and a global model computation device 900. The basic operation of the federated learning system 90 is as follows. The local model training devices 700₁, . . . , 700_{M} train local models using training data recorded in their own recording units. After completion of training, the local model training devices 700₁, . . . , 700_{M} transmit the local models to the global model computation device 900 via a network 800. The global model computation device 900 computes a global model by using the received local models. After computation is completed, the global model computation device 900 transmits the global model to the local model training devices 700₁, . . . , 700_{M} via the network 800. The local model training devices 700₁, . . . , 700_{M} re-learn the local models using the received global model. By repeating this operation, the federated learning system 90 advances model training. In this case, the global model computation device 900 manages parameters of the local models using a local model management table.

When the federated learning technique is used, since training data is not taken outside of a local model training device, anxiety about taking the data out can be eliminated, and at the same time, high speed can be attained through parallel learning. However, if parameters of a model that is being trained are traced and leak from the process of communication between the local model training devices 700₁, . . . , 700_{M} and the global model computation device 900, for example, there is a risk of training data being inferred. In order to avoid such a risk, using secure computation for computation of a global model can be considered.

Secure computation is a method of obtaining results of a designated arithmetic operation without restoring encrypted numerical values (refer to Reference NPL 1, for example). In the method of Reference NPL 1, encryption for distributing a plurality of pieces of information that can be used to restore numerical values to three secure computation devices can be performed to maintain a state in which results of addition/subtraction, constant summation, multiplication, constant multiplication, logical operations (negation, logical product, logical sum, and exclusive logical sum), and data format conversion (integer, binary) have been distributed to the three secure computation devices without restoring numerical values, that is, an encrypted state. In general, the number of distributions is not limited to 3 and can be N (N is an integer of 3 or more), and a protocol for realizing secure computation by cooperative computation by N secure computation devices is called a multiparty protocol.

(Reference NPL 1: Koji Chida, Koki Hamada, Dai Igarashi, and Katsumi Takahashi, “Reconsideration of Lightweight Verifiable 3-Party Secure Function Computation,” In CSS, 2010.)

### CITATION LIST

### Non Patent Literature

[NPL 1] McMahan, B., E. Moore, D. Ramage, et al., “Communication-efficient learning of deep networks from decentralized data,” In Artificial Intelligence and Statistics, pp. 1273-1282, 2017.

### SUMMARY OF INVENTION

### Technical Problem

In general, the number of devices for training local models tends to be excessively high compared to the number of devices constituting a secure computation system for computing a global model. In such a case, due to the time taken for processing of registering local models in the secure computation system, there is a problem that a time required for model training increases as a whole.

Accordingly, an object of the present invention is to provide a technique for efficiently training a model by providing a function of training a local model by a device constituting a secure computation system for computing a global model in federated learning.

### Solution to Problem

One aspect of the present invention is a secure global model computation device in a federated learning system including K secure global model computation devices for training local models using training data, wherein K is an integer of 3 or more, N is an integer satisfying 3≤N≤K, and arbitrary N secure global model computation devices among the K secure global model computation devices are able to constitute a secure global model computation system for performing secure computation of a global model from N local models, the secure global model computation device including: a selection unit configured to transmit a query for checking an availability of computation resources to K−1 secure global model computation devices excluding the secure global model computation device itself and to select N−1 secure global model computation devices having a large availability of computation resources from the K−1 secure global model computation devices; and a system configuration unit configured to configure a secure global model computation system using N secure global model computation devices obtained by combining the selected N−1secure global model computation devices and the secure global model computation device itself.

One aspect of the present invention is a secure global model computation device in a federated learning system including K secure global model computation devices for training local models using training data, wherein K is an integer of 3 or more, P is an integer of 2 or more, N is an integer satisfying 3≤N≤K/P, and arbitrary N secure global model computation devices among the K secure global model computation devices are able to constitute a secure global model computation system for performing secure computation of a global model from N local models, the secure global model computation device including: a selection unit configured to transmit a query for checking an availability of computation resources to K-(p−1)N−1 secure global model computation devices excluding the secure global model computation device itself among K-(p−1)N secure global model computation devices (where p is an integer satisfying 1≤p≤P) which are not selected for a secure global model computation system configuration and to select N−1 secure global model computation devices having a large availability of computation resources from the K-(p−1)N−1 secure global model computation devices; a system configuration unit configured to configure a secure global model computation system (hereinafter referred to as a p-th secure global model computation system) using N secure global model computation devices obtained by combining the selected N−1 secure global model computation devices and the secure global model computation device itself; and a local model training unit configured to train a local model using, as initial values of parameters of the local model, parameters of a global model of a p′-th secure global model computation system (where p′ is an integer satisfying σ(p′)=σ(p)−1) in one time of training among L times of training and parameters of a global model of the p-th secure global model computation system in the remaining (L−1) times of training among the L times of training if p is an integer satisfying σ(p)>1, and to train a local model using, as initial values of parameters of the local model, the parameters of the global model of the p-th secure global model computation system in the second and subsequent training if p is an integer satisfying σ(p)=1, wherein σ is a permutation of a set {1, . . . , P} and L is an integer of 2 or more.

### Advantageous Effects of Invention

According to the present invention, it is possible to efficiently train a model by providing a function of training a local model by a device constituting a secure computation system for computing a global model in federated learning.

### BRIEF DESCRIPTION OF DRAWINGS

FIG. 1 is a diagram showing a basic configuration of a federated learning system 90.

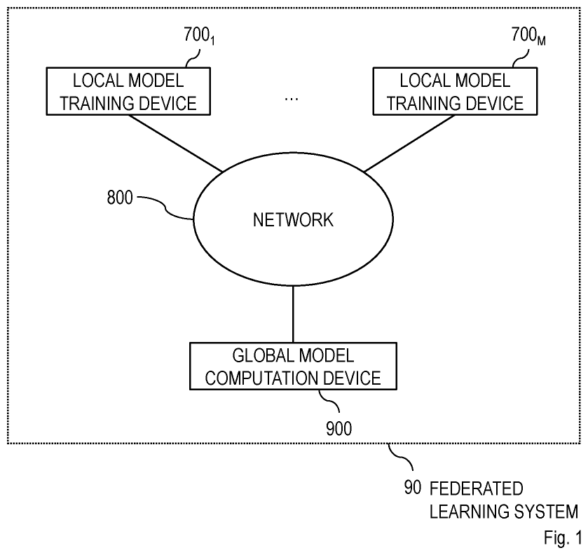

FIG. 2 is a block diagram showing a configuration of a federated learning system 10.

FIG. 3 is a block diagram showing a configuration of a secure global model computation device 100ₙ.

FIG. 4 is a flowchart showing an operation of the federated learning system 10.

FIG. 5 is a block diagram showing a configuration of a local model generation unit 130ₙ.

FIG. 6 is a flowchart showing an operation of the local model generation unit 130ₙ.

FIG. 7 is a diagram showing an example of a functional configuration of a computer that realizes each device in embodiments of the present invention.

### DESCRIPTION OF EMBODIMENTS

The following describes embodiments of the present invention in detail. Note that constituent elements having the same function will be denoted by the same reference numerals and redundant description thereof will be omitted.

A notation method used in this specification will be described before the embodiments are described.

\hat{ } (caret) denotes superscript. For example, x^{y\hat{ }z} indicates that y^{z} is a superscript to x, and x_{y\hat{ }z} indicates that y^{z} is a subscript to x. In addition, _ (underscore) indicates a subscript. For example, x^{y_z} indicates that y_{z} is a superscript to x, and x_{y_z} indicates that y_{z} is a subscript to x. Superscripts “\hat{ }” and “˜” as in \hat{ }x and ˜x for a certain character x would normally be written directly above “x,” but are written as \hat{ }x or ˜x here due to restrictions on notation in this specification.

### Technical Background

### Secure Computation

Secure computation in the present invention is constructed using a combination of arithmetic operations in existing secure computation. Arithmetic operations necessary for the secure computation include, for example, concealment, addition, subtraction, multiplication, division, logical operations (negation, logical product, logical sum, and exclusive logical sum), and comparison operations (=, <, >, ≤, and >). Several arithmetic operations including notation will be described below.

### Concealment

[[x]] is assumed to be a value obtained by concealing x by secret sharing (hereinafter referred to as a share of x). Any method can be used as a secret sharing method. For example, Shamir secret sharing on GF(2⁶¹−1) and replicated secret sharing on z₂ can be used.

A plurality of secret sharing methods may be used in combination in one algorithm. In this case, it is assumed that they can be interconverted as appropriate.

Further, it is assumed that [[\vec{ }x]]=([[x₁]], . . . , [[x_{N}]]) for an N-dimensional vector \vec{ }x=(x₁, . . . , x_{N}). That is, [[\vec{ }x]] is a vector having a share [[xₙ]] of an n-th element xₙ of \vec{ }x as an n-th element. Similarly, for an M×N matrix A=(a_{m, n}) (1≤m≤M, 1≤n≤N), [[A]] is assumed to be a matrix having a share [[a_{m, n}]] of an (m, n)-th element a_{m, n} of A as an (m, n)-th element.

Note that x is referred to as plaintext of [[x]].

As a method of obtaining [[x]] from x (concealment) and a method of obtaining x from [[x]] (restoration), specifically, there are methods described in Reference NPL 1 and Reference NPL 2.

(Reference NPL 2: Shamir, A, “How to share a secret,” Communications of the ACM, Vol. 22, No. 11, pp. 612-613, 1979.)

### Addition, Subtraction, Multiplication, and Division

Addition [[x]]+[[y]] according to secure computation has [[x]] and [[y]] as inputs and [[x+y]] as an output. Subtraction [[x]]−[[y]] according to secure computation has [[x]] and [[y]] as inputs and [[x−y]] as an output. Multiplication [[x]]×[[y]] (which may be represented as mul([[x]], [[y]])) according to secure computation has [[x]] and [[y]] as inputs and [[xxy]] as an output. Division [[x]]/[[y]] (which may be represented as div ([[x]], [[y]])) according to secure computation has [[x]] and [[y]] as inputs [[x/y]] as an output.

As specific methods of addition, subtraction, multiplication and division, there are methods described in Reference NPL 3 and Reference NPL 4.

(Reference NPL 3: Ben-or, M., Goldwasser, S. and Wigderson, A., “Completeness theorems for non-cryptographic fault-tolerant distributed computation,” Proceedings of the twentieth annual ACM symposium on Theory of computing, ACM, pp. 1-10, 1988.)

(Reference NPL 4: Gennaro, R., Rabin, M. O. and Rabin, T., “Simplied VSS and fast-track multiparty communications with applications to threshold cryptography,” Proceedings of the seventeenth annual ACM symposium on Principles of distributed computing, ACM, pp. 101-111, 1998.)

### Logical Operations

Negation not [[x]] according to secure computation has [[x]] as an input and [[not (x)]] as an output. Logical product and ([[x]], [[y]]) according to secure computation has [[x]] and [[y]] as inputs and [[and (x, y)]] as an output. Logical sum or ([[x]], [[y]]) according to secure computation has [[x]] and [[y]] as inputs and [[or (x, y)]] as an output. Exclusive logical sum xor ([[x]], [[y]]) according to secure computation has [[x]] and [[y]] as inputs and [[xor (x, y)]] as an output.

Note that logical operations can be easily constructed by combining addition, subtraction, multiplication, and division.

### Comparison Operations

Equal sign decision=([[x]], [[y]]) (which may be represented as equal ([[x]], [[y]])) according to secure computation has [[x]] and [[y]] as inputs, [[1]] as an output when x=y, and [[0]] as an output in other cases. Comparison <([[x]], [[y]]) according to secure computation has [[x]] and [[y]] as inputs, [[1]] as an output when x<y, and [[0]] as an output in other cases. Comparison >([[x]], [[y]]) according to secure computation has [[x]] and [[y]] as inputs, [[1]] as an output when x>y, and [[0]] as an output in other cases. Comparison ≤([[x]], [[y]]) according to secure computation has [[x]] and [[y]] as inputs, [[1]] as an output when x≤y, and [[0]] as an output in other cases. Comparison ≥([[x]], [[y]]) according to secure computation has [[x]] and [[y]] as inputs, [[1]] as an output when x≥y, and [[0]] as an output in other cases.

Note that comparison operations can be easily constituted by combining logical operations.

### First Embodiment

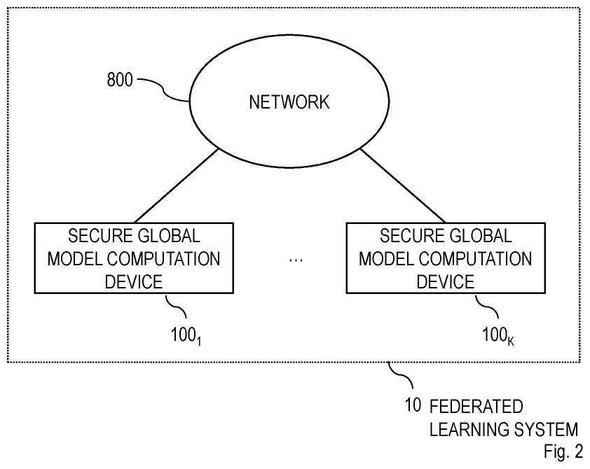

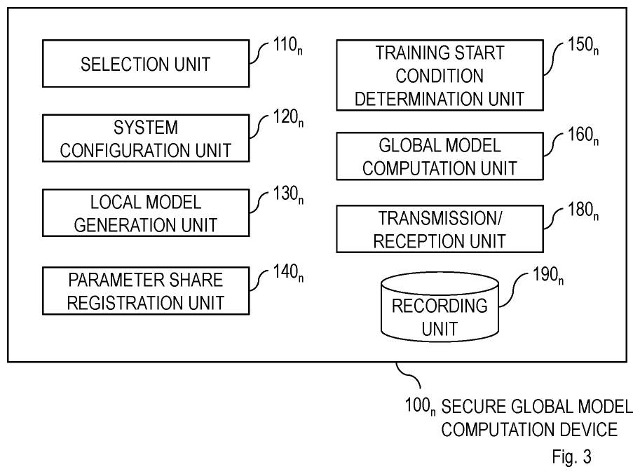

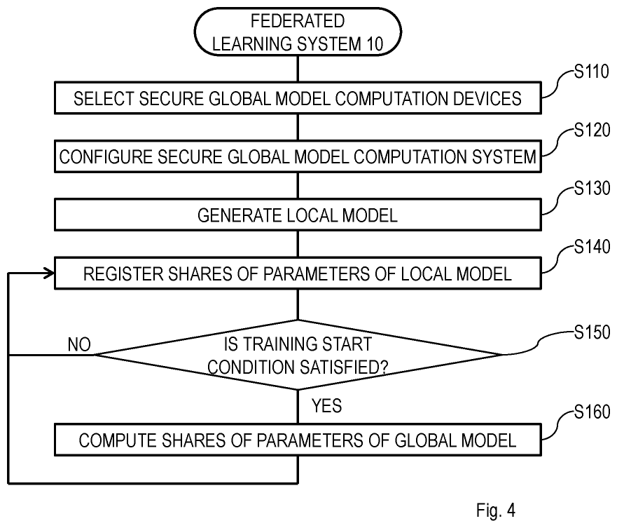

Hereinafter, a federated learning system 10 will be described with reference to FIG. 2 to FIG. 4. FIG. 2 is a block diagram showing a configuration of the federated learning system 10. The federated learning system 10 includes K secure global model computation devices 100₁, . . . , 100_{K} (K is an integer of 3 or more) that train local models using training data. The secure global model computation devices 100₁, . . . , 100_{K} are connected to a network 800 and can communicate with each other. The network 800 may be, for example, a communication network such as the Internet or a broadcast communication path. FIG. 3 is a block diagram showing a configuration of a secure global model computation device 100ₙ (1≤n≤K). FIG. 4 is a flowchart showing an operation of the federated learning system 10.

As shown in FIG. 3, the secure global model computation device 100, includes a selection unit 110ₙ, a system configuration unit 120ₙ, a local model generation unit 130ₙ, a parameter share registration unit 140ₙ, a training start condition determination unit 150ₙ, a global model computation unit 160ₙ, a transmission/reception unit 180ₙ, and a recording unit 190ₙ. Each component of the secure global model computation device 100ₙ excluding the selection unit 110ₙ, the system configuration unit 120ₙ, the local model generation unit 130ₙ, the parameter share registration unit 140ₙ, the transmission/reception unit 180ₙ, and the recording unit 190ₙ is configured to be able to execute operations necessary to realize the function of each component among operations required for global model computation, such as concealment, addition, subtraction, multiplication, division, logical operations, and comparison operations. Specific functional configurations for realizing individual operations in the present invention are sufficient to be configurations capable of executing existing algorithms, and since these are conventional configurations, detailed description thereof will be omitted. Further, the recording unit 190, is a component for recording information necessary for processing of the secure global model computation device 100ₙ. The recording unit 190ₙrecords, for example, training data, parameters of a local model, and parameters of a global model. Note that training data is updated as appropriate. Further, a global model is a model having the same structure as a local model.

Arbitrary N (N is an integer satisfying 3≤N≤K) secure global model computation devices among K secure global model computation devices can constitute a secure global model computation system for performing secure computation of a global model from N local models.

According to cooperative computation by arbitrary N secure global model computation devices among K secure global model computation devices, the secure global model computation system composed of the N secure global model computation devices realizes secure computation of a global model which is a multiparty protocol. Accordingly, when the N secure global model computation devices are assumed to be secure global model computation devices 100_{i_1}, . . . , 100_{1_N} (where i₁, . . . , i_{N} are integers satisfying 1≤i₁< . . . <i_{N}≤K), a training start condition determination means 150 (not shown) of the secure global model computation system composed of the N secure global model computation devices is composed of training start condition determination units 150_{i_1}, . . . , 150_{i_N}, and a global model computation means 160 (not shown) is composed of global model computation units 160_{i_1}, . . . , 160_{i_N}.

Hereinafter, the operation of the federated learning system 10 will be described with reference to FIG. 4.

In S110, a selection unit 110_{k_0} of one secure global model computation device 100_{k_0} (where k₀ is an integer satisfying 1≤k₀≤K) among the secure global model computation devices 100ₙ (1≤n≤K) transmits a query for checking an availability of computation resources to K−1 secure global model computation devices excluding the secure global model computation devices 100_{k_0} itself using a transmission/reception unit 180_{k_0} and selects N−1 secure global model computation devices having a large availability of computation resources from the K−1 secure global model computation devices. Hereinafter, the secure global model computation device 100_{k_0} is referred to as a master secure global model computation device. N secure global model computation devices obtained by combining the selected N−1 secure global model computation devices and the master secure global model computation device are defined as secure global model computation devices 100_{i_1}, . . . , 100_{i_N} (where i₁, . . . , i_{N} are integers satisfying 1≤i₁< . . . <i_{N}≤K). Therefore, k₀ coincides with any one of i₁, . . . , i_{N}. Here, it is assumed that k₀=i_{˜n} (where \tilde{ }n is an integer satisfying 1≤\tilde{ }n≤N). Further, computation resources are, for example, a CPU and a communication unit of a general-purpose computer used for the configuration of a secure global model computation device.

In S120, a system configuration unit 110_{i_˜n} of a secure global model computation device 100_{i_˜n} serving as a master secure global model computation device exchanges data necessary to configure a secure global model computation system with secure global model computation devices 100_{i_1}, . . . , 100_{i_˜n-1}, 100_{i_˜n+1}, . . . , 100_{i_N} using a transmission/reception units 180_{i_˜n} , and configures the secure global model computation system using the N secure global model computation devices 100_{i_1}, . . . , 100_{i_N}. The data necessary to configure the secure global model computation system is, for example, network addresses (for example, IP addresses) of the secure global model computation devices constituting the secure global model computation system.

In S130, a local model generation unit 130ₙ of the secure global model computation device 100ₙ (n=i₁, . . . , i_{N}) generates a local model.

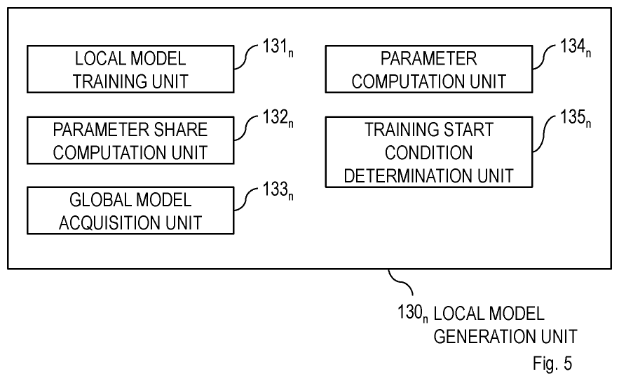

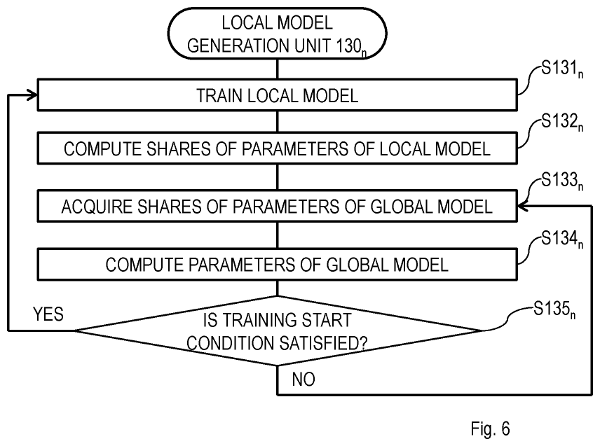

Hereinafter, the local model generation unit 130ₙ will be described with reference to FIGS. 5 and 6. FIG. 5 is a block diagram showing a configuration of the local model generation unit 130ₙ. FIG. 6 is a flow chart showing an operation of the local model generation unit 130ₙ. As shown in FIG. 5, the local model generation unit 130ₙ (1≤n≤K) includes a local model training unit 131ₙ, a parameter share computation unit 132ₙ, a global model acquisition unit 133ₙ, a parameter computation unit 134ₙ, and a training start condition determination unit 135ₙ.

Hereinafter, the operation of the local model generation unit 130ₙ (n=i₁, . . . , i_{N}) will be described with reference to FIG. 6.

In S131ₙ, the local model training unit 131ₙ trains a local model using training data recorded in a recording unit 190ₙ. In the first training of a local model, the local model training unit 131ₙ may set initial values of parameters of the local model using initial values recorded in advance in the recording unit 190ₙ or may set the initial values of the parameters of the local model using initial values generated using random numbers. In the second and subsequent training of a local model, the local model training unit 131ₙ sets initial values of parameters of the local model using shares of parameters of a global model acquired in S133ₙ which will be described later.

In S132ₙ, the parameter share computation unit 132ₙ calculates shares of the parameters of the local model from the parameters of the local model trained in S131ₙ. When computation is finished, the parameter share computation unit 132ₙ transmits the shares of the parameters of the local model to the secure global model computation devices 100_{i_1}, . . . , 100_{i_n-1}, 100_{i_n+1}, . . . , 100_{i_N} excluding the secure global model computation device 100ₙ itself using the transmission/reception unit 180ₙ.

In S133ₙ, the global model acquisition unit 133ₙ acquires the shares of the parameters of the global model from the secure global model computation devices 100_{i_1}, . . . , 100_{i_n-1}, 100_{i_n+1}, . . . , 100_{i_N} excluding the secure global model computation device itself using the transmission/reception unit 180ₙ after the end of processing of S132ₙ or after the elapse of a predetermined time from the end of processing of S135ₙ.

In S134ₙ, the parameter computation unit 134, computes the parameters of the global model from the shares of the parameters of the global model acquired in S133ₙ and shares of parameters of the global model calculated by itself. The parameter computation unit 134ₙ records the computed parameters of the global model in the recording unit 190ₙ. Note that, in the recording unit 190ₙ, at least two sets of the parameters of the global model, that is, the parameters of the global model obtained through the current computation and the parameters of the global model obtained through the previous computation are recorded.

In S135ₙ, the training start condition determination unit 135ₙ compares the parameters of the global model computed in S134ₙ with the parameters of the global model obtained in the previous computation, executes processing of S131ₙ upon determining that a training start condition is satisfied in a case in which the two sets of the parameters of the global model are different, and returns to processing of S133ₙ upon determining that the training start condition is not satisfied in other cases.

In S140, the parameter share registration unit 140ₙof the secure global model computation device 100ₙ (n=i₁, . . . , i_{N}) takes shares of parameters of a local model trained by one secure global model training device among secure global model computation devices 100_{i_1}, . . . , 100_{i_n-1}, 100_{i_n+1}, . . . , 100_{i_N} excluding the secure global model computation device 100ₙ itself received using the transmission/reception unit 180ₙ or shares of parameters of a local model trained by the secure global model computation device 100ₙ itself as inputs, and registers the shares of the parameters of the local model in a local model management table. Here, the local model management table is a table for managing shares of parameters of N local models and is recorded in the recording unit 190ₙ.

In S150, the training start condition determination means 150 executes processing of S160 upon determining that a training start condition is satisfied in a case in which the number of newly registered local models exceeds a predetermined value (the value is 1 or more and N or less), or is equal to or greater than the predetermined value after the previous global model computation, and returns to processing of S140 upon determining that the training start condition is not satisfied in other cases.

In S160, the global model computation means 160 calculates the shares of the parameters of the global model using shares of parameters of local models managed by the local model management table. The global model computation means 160 sets, for example, the average of the shares of the corresponding parameters of the first local model to the N-th local model as the shares of the parameters of the global model.

By periodically executing processing of S110, a combination of secure global model computation devices constituting the secure global model computation system can be periodically changed.

According to an embodiment of the present invention, devices constituting a secure computation system for computing a global model have a function of training a local model and thus a model can be efficiently trained in federated learning. Further, secure global model computation devices have a local model training function and secure global model computation devices having an availability of computation resources constitute a secure global model computation system, and thus the amount of computation and the amount of communication can be reduced and a model can be efficiently trained. Furthermore, by periodically changing a combination of secure global model computation devices constituting a secure global model computation system, a leakage risk due to collusion of an operator can be curbed.

### Second Embodiment

Although one secure global model computation system is configured in the first embodiment, the number of configured secure global model computation systems may be two or more. In this case, each of two or more secure global model computation systems forms one layer, and a federated learning system trains a model as a whole, such as computation in a neural network, using shares of parameters of a global model computed by the secure global model computation system constituting a certain layer to set initial values when a secure global model computation system constituting a next layer trains a local model.

Hereinafter, an example of a case in which the federated learning system 10 constitutes two secure global model computation systems will be described.

In this case, arbitrary N (N is an integer satisfying 3≤N≤K/2) secure global model computation devices among K secure global model computation devices can constitute a secure global model computation system for performing secure computation of a global model from N local models.

Hereinafter, the operation of the federated learning system 10 will be described with reference to FIG. 4.

In S110, a selection unit 110_{k_0} of one secure global model computation device 100_{k_0} (where k₀ is an integer satisfying 1≤k₀≤K) among the secure global model computation devices 100ₙ (1≤n≤K) transmits a query for checking an availability of computation resources to K−1 secure global model computation devices excluding the secure global model computation devices 100_{k_0} itself using a transmission/reception unit 180_{k_0} and selects N−1 secure global model computation devices having a large availability of computation resources from the K−1 secure global model computation devices. Hereinafter, the secure global model computation device 100_{k_0} is referred to as a first master secure global model computation device. N secure global model computation devices obtained by combining the selected N−1 secure global model computation devices and the first master secure global model computation device are defined as secure global model computation devices 100_{i_1}, . . . , 100_{i_N} (where i₁, . . . , i_{N} are integers satisfying 1≤i₁< . . . <i_{N}≤K). Therefore, k₀ coincides with any one of i₁, . . . , i_{N}. Here, it is assumed that k₀=i_{˜n} (where \tilde{ }n is an integer satisfying 1≤\tilde{ }n≤N).

Similarly, a selection unit 110_{k_1} of one secure global model computation devices 100_{k_1} (where k₁ is an integer satisfying 1≤k₁≤K and differs from any of i₁, . . . , i_{N}) among the secure global model computation devices 100ₙ (1≤n≤K), that is, one secure global model computation devices 100_{k_1} among K-N secure global model computation devices 100ₙ which are not selected to constitute the secure global model computation system transmits a query for checking an availability of computation resources to K-N−1 secure global model computation devices 100ₙ excluding the secure global model computation devices 100_{k_1}itself and the secure global model computation devices 100_{i_1}, . . . , 100_{i_N} using a transmission/reception unit 180_{k_1} and selects N−1 secure global model computation devices having a large availability of computation resources from the K-N−1 secure global model computation devices 100ₙ. Hereinafter, the secure global model computation device 100_{k_1} is referred to as a second master secure global model computation device. N secure global model computation devices obtained by combining the selected N−1 secure global model computation devices and the second master secure global model computation device are defined as secure global model computation devices 100_{i_N+1}, . . . , 100_{i_2N} (where i_{N+1}, . . . , i_{2N} are integers satisfying 1≤i_{N+1}< . . . <i_{2N}≤K and differs from any of i₁, . . . , i_{N}). Therefore, k₁ coincides with any one of i_{N+1}, . . . , i_{2N}. Here, k₁=i_{\hat{ }n} (where \hat{ }n is an integer satisfying 1≤\hat{ }n≤N). It is assumed that the secure global model computation device 100_{k_1} previously ascertains that the secure global model computation devices 100_{i_1}, . . . , 100_{i_N} cannot be selected, for example, through broadcasting by the secure global model computation device 100_{i_˜n}.

In S120, the system configuration unit 110_{i_˜n} of the secure global model computation device 110_{i_˜n} serving as the first master secure global model computation device exchanges data necessary to configure a secure global model computation system with the secure global model computation devices 100_{i_1}, . . . , . . . , 100_{i_˜n-1}, 100_{i_˜n+1}, . . . , 100_{i_N} using the transmission/reception unit 180_{i_˜n} and configures a secure global model computation system (hereinafter referred to as a first secure global model computation system) using the N secure global model computation devices 100_{i_1}, . . . , 100_{i_N}.

Similarly, the system configuration unit 110_{i_\hat{ }n} of the secure global model computation device 100_{i_\hat{ }n} serving as the second master secure global model computation device exchanges data necessary to configure a secure global model computation system with the secure global model computation devices 100_{i_N+1}, . . . , 100_{i_\hat{ }n-1}, 100_{i_\hat{ }n+1}, . . . , 100_{i_2N} using the transmission/reception unit 180_{i_\hat{ }n} and configures a secure global model computation system (hereinafter referred to as a second secure global model computation system) using the N secure global model computation devices 100_{i_N+1}, . . . , 100_{i_2N} .

In S130, a local model generation unit 130ₙ of the secure global model computation device 100ₙ (n=i₁, . . . , i_{N}) generates a local model.

Similarly, the local model generation unit 130ₙ of the secure global model computation device 100ₙ (n=i₁, . . . , i_{2N}) generates a local model.

Hereinafter, the operation of the local model generation unit 130ₙ (n=i₁, . . . , i_{2N}) will be described with reference to FIG. 6.

In S131ₙ, the local model training unit 131ₙ trains a local model using training data recorded in a recording unit 190ₙ. From the first training of the local model, the local model training unit 131, sets initial values of parameters of the local model using shares of parameters of a global model acquired in S133, which will be described later.

In S132ₙ, the parameter share computation unit 132ₙ computes shares of the parameters of the local model from the parameters of the local model trained in S131ₙ. When the computation is finished, the parameter share computation unit 132ₙ transmits the shares of the parameters of the local model to the secure global model computation devices 100_{i_N+1}, . . . , 100_{i_n-1}, 100_{i_n+1}, . . . , 100_{i_2N} excluding the secure global model computation device 100, itself using the transmission/reception unit 180ₙ.

In S133ₙ, the global model acquisition unit 133ₙ acquires the shares of the parameters of the global model from the secure global model computation devices 100_{i_1}, . . . , 100_{i_N} or the secure global model computation devices 100_{i_N+1}, . . . , 100_{i_n-1}, _{i_n+1}, . . . , 100_{i_2N} excluding the secure global model computation device 100ₙ itself using the transmission/reception unit 180ₙ after the end of processing of S132ₙ or after the elapse of a predetermined time from the end of processing of S135ₙ. In the first acquisition, shares of parameters of a global model are acquired from the secure global model computation devices 100_{i_1}, . . . , 100_{i_N}. In the second and subsequent acquisition, shares of parameters of a global model are acquired from the secure global model computation devices 100_{i_1}, . . . , 100_{i_N} in one time of acquisition among L times of acquisition (where L is an integer of 2 or more), and shares of parameters of a global model are acquired from the secure global model computation devices 100_{i_N+1}, . . . , 100_{i_n-1}, 100_{i_n+1}, . . . , 100_{i_2N} in the remaining L−1 times of acquisition among the L times of acquisition.

Therefore, the local model training unit 131ₙ trains a local model by using the shares of the parameters of the global model of the first secure global model computation system in one time of training among L times of training and the shares of the parameters of the global model of the second secure global model computation system in the remaining (L−1) times of training among L times of training as initial values of the parameters of the local model.

In S134ₙ, the parameter computation unit 134ₙ computes parameters of a global model from the shares of the parameters of the global model acquired in S133ₙ or the shares of the parameters of the global model acquired in S133ₙ and the shares of the parameters of the global model calculated by the secure global model computation device itself. The parameter computation unit 134ₙ records the calculated parameters of the global model in the recording unit 190ₙ. Note that, in the recording unit 190ₙ, at least two sets of the parameters of the global model, that is, the parameters of the global model obtained through the current computation and the parameters of the global model obtained through the previous computation are recorded.

In S135ₙ, the training start condition determination unit 135ₙ compares the parameters of the global model computed in S134ₙ with the parameters of the global model obtained in the previous computation, executes processing of S131ₙ upon determining that a training start condition is satisfied in a case in which the two sets of the parameters of the global model are different, and returns to processing of S133ₙ upon determining that the training start condition is not satisfied in other cases.

Although the global model acquisition unit 133ₙ of the secure global model computation device 100ₙ (n=i_{N+1}, . . . , i_{2N}) acquires the shares of the parameters of the global model generated by the global model acquisition unit 133ₙ of the secure global model computation device 100ₙ (n=i₁, . . . , i_{N}) in the description of the operation of the local model generation unit 130ₙ of the secure global model computation device 100ₙ (n=i₁, . . . , i_{N}) and the local model generation unit 130ₙ of the secure global model computation device 100ₙ (n=i_{N+1}, . . . , i_{2N}) in S130n, above may be reversed. That is, the global model acquisition unit 133ₙ of the secure global model computation device 100ₙ (n=i₁, . . . , i_{N}) may acquire the shares of the parameters of the global model generated by the global model acquisition unit 133ₙ of the secure global model computation device 100ₙ (n=i_{N+1}, . . . , i_{2N}).

In S140, the parameter share registration unit 140ₙ of the secure global model computation device 100ₙ (n=i₁, . . . , i_{N}) takes shares of parameters of a local model trained by one secure global model training device among secure global model computation devices 100_{i_1}, . . . , 100_{i_n-1}, 100_{i_n+1}, . . . , 100_{i_N+1} excluding the secure global model computation device 100ₙ itself received using the transmission/reception unit 180ₙ or shares of parameters of a local model trained by the secure global model computation device 100ₙ itself as inputs, and registers the shares of the parameters of the local model in a local model management table.

Similarly, the parameter share registration unit 140ₙ of the secure global model computation device 100ₙ (n=i_{N+1}, . . . , i_{2N}) takes shares of parameters of a local model trained by one secure global model training device among secure global model computation devices 100_{i_N+1}, . . . , 100_{i_n-1}, 100_{i_n+1}, . . . , 100_{i_2N} excluding the secure global model computation device 100ₙ itself received using the transmission/reception unit 180ₙ or shares of parameters of a local model trained by the secure global model computation device 100ₙ itself as inputs, and registers the shares of the parameters of the local model in a local model management table.

In S150, each of the training start condition determination means 150 of the first secure global model computation device and the training start condition determination means 150 of the second secure global model computation device executes processing of S160 upon determining that a training start condition is satisfied in a case in which the number of newly registered local models exceeds a predetermined value (the value is 1 or more and N or less), or is equal to or greater than the predetermined value after the previous global model computation, and returns to processing of S140 upon determining that the training start condition is not satisfied in other cases.

In S160, each of the global model computation means 160 of the first secure global model computation device and the global model computation means 160 of the second secure global model computation device computes shares of parameters of a global model using shares of parameters of local models managed by the local model management table.

Next, a description will be briefly given of a case in which P is an integer of 2 or more and the federated learning system 10 constitutes P secure global model computation systems (refer to FIG. 4).

In this case, arbitrary N (N is an integer satisfying 3≤N≤K/P) secure global model computation devices among K secure global model computation devices can constitute a secure global model computation system for performing secure computation of a global model from N local models.

In S110, the selection unit 110, of one secure global model computation device 100ₙ (hereinafter referred to as a p-th master secure global model computation device) among K-(p−1)N secure global model computation devices (p is an integer satisfying 1≤p≤P) which are not selected for a secure global model computation system configuration, transmits a query for checking an availability of computation resources to K-(p−1)N−1 secure global model computation devices excluding the secure global model computation device 100ₙ itself using the transmission/reception unit 180ₙ, and selects N−1 secure global model computation devices having a large availability of computation resources from the K-(p−1)N−1 secure global model computation devices.

In S120, the system configuration unit 120, of the p-th master secure global model computation device 100ₙ exchanges data required to configure a secure global model computation system with the N secure global model computation devices obtained by combining the N−1 secure global model computation devices selected in S110 and the p-th master secure global model computation device 100ₙ itself using the transmission/reception unit 180ₙ, and configures a secure global model computation system (referred to as a p-th secure global model computation system) using the N secure global model computation devices.

In S130, the local model generation unit 130ₙ of the secure global model computation device 100ₙ constituting the p-th secure global model computation system generates a local model. In this case, the local model training unit 131ₙ included in the local model generation unit 130ₙ trains a local model using training data. Specifically, on the assumption that σ is a permutation of a set {1, . . . , P} and L is an integer of 2 or more, the local model training unit 131ₙ trains a local model using, as initial values of parameters of the local model, parameters of a global model of a p′-th secure global model computation system (where p′ is an integer satisfying σ(p′)=σ(p)−1) in one time of training among L times of training and parameters of a global model of the p-th secure global model computation system in the remaining (L−1) times of training among the L times of training if p is an integer satisfying σ(p)>1, and trains a local model using, as initial values of parameters of the local model, the parameters of the global model of the p-th secure global model computation system in the second and subsequent training if p is an integer satisfying σ(p)=1. Note that it can be ascertained that p′ is an integer satisfying 1≤p′≤p and different from p from σ(p′)=σ(p)−1.

In S140, the parameter share registration unit 140ₙ of the secure global model computation device 100ₙ constituting the p-th secure global model computation system takes the shares of the parameters of the local model trained by the secure global model computation device 100ₙ constituting the p-th secure global model computation system as inputs, and registers the shares of the parameters of the local model in a local model management table.

In S150, the training start condition determination means 150 of the p-th master secure global model computation device executes processing of S160 upon determining that a training start condition is satisfied in a case in which the number of newly registered local models exceeds a predetermined value (the value is 1 or more and N or less), or is equal to or greater than the predetermined value after the previous global model computation, and returns to processing of S140 upon determining that the training start condition is not satisfied in other cases.

In S160, the global model computation means 160 of the p-th master secure global model computation device computes shares of parameters of a global model using the shares of the parameters of the local model managed by the local model management table.

According to an embodiment of the present invention, devices constituting a secure computation system for computing a global model have a function of training a local model and thus a model can be efficiently trained in federated learning. Further, secure global model computation devices have a local model training function and secure global model computation devices having an availability of computation resources constitute a secure global model computation system, and thus the amount of computation and the amount of communication can be reduced and a model can be efficiently trained. Furthermore, each of two or more secure global model computation systems forms one layer, and the federated learning system trains a model as a whole, such as computation in a neural network, and thus efficient model training using a global model can be realized.

### Additional Note

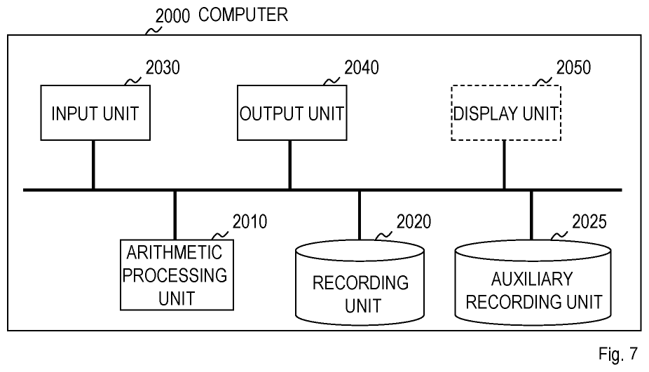

The processing of each unit of each device described above may be implemented by a computer, and in this case, the processing details of the functions that each device should have are described by a program. Then, various types of processing functions in each device described above are realized on a computer 2000 by causing this program to be read by a recording unit 2020 of the computer shown in FIG. 7 and operating an arithmetic processing unit 2010, an input unit 2030, an output unit 2040, an auxiliary recording unit 2025, and the like.

The device of the present invention includes, for example, as a single hardware entity, an input unit that can receive a signal from the outside of the hardware entity, an output unit that can output a signal to the outside of the hardware entity, a communication unit to which a communication device (for example, a communication cable) capable of communicating with the outside of the hardware entity can be connected, a CPU (Central Processing Unit: which may include a cache memory, a register, and the like) that is an arithmetic processing unit, a RAM and a ROM which are memories, an external storage device that is a hard disk, and a bus which connects the input unit, output unit, communication unit, CPU, RAM, ROM, and external storage device such that data can be exchanged therebetween. Further, if necessary, the hardware entity may be provided with a device (drive) or the like capable of reading and writing data from/to a recording medium such as a CD-ROM. An example of a physical entity including such hardware resources is a general-purpose computer.

The external storage device of the hardware entity stores programs necessary for realizing the functions described above, data necessary for processing the programs, and the like (not limited to the external storage device, for example, the program may be stored in a ROM which is a read-only storage device). In addition, data and the like obtained by processing these programs are appropriately stored in a RAM, an external storage device, or the like.

In the hardware entity, each program stored in the external storage device (or a ROM or the like) and data necessary for processing of each program are read into a memory as necessary and appropriately interpreted, executed, or processed by a CPU. As a result, the CPU realizes predetermined functions (the components described above as units, means, etc.). In other words, each of the components of the embodiments of the present invention may be constituted by processing circuitry.

As described above, when the processing function in the hardware entity (the device according to the present invention) described in the above-described embodiments is implemented by the computer, processing content of the function included in the hardware entity is written by the program. Then, by executing this program on the computer, the processing function in the above-described hardware entity is implemented on the computer.

A program describing this processing content can be recorded on a computer-readable recording medium. The computer-readable recording medium is, for example, a non-transitory recording medium, and specifically a magnetic recording device, an optical disc, or the like.

The program is distributed, for example, by sales, transfer, or lending of a portable recording medium such as a DVD or a CD-ROM on which the program is recorded. In addition, the distribution of the program may be performed by storing the program in advance in a storage device of a server computer and transferring the program from the server computer to another computer via a network.

The computer executing such a program first temporarily stores the program recorded in the portable recording medium or the program transferred from the server computer, for example, in the auxiliary recording unit 2025, which is its own non-transitory storage device. Then, when executing processing, the computer reads the program stored in the auxiliary recording unit 2025 serving as its own non-transitory storage device onto the recording unit 2020, and executes processing according to the read program. Alternatively, as another form of executing the program, the computer may read the program directly from the portable recording medium onto the recording unit 2020, and execute processing according to the program, or the computer may sequentially execute processing according to the program received from a server computer every time the program is transferred thereto from the server computer. Furthermore, instead of transferring the program to the computer from a server computer, the processing described above may be executed by a so-called ASP (Application Service Provider) type service, in which a processing function is realized by execution commands and result acquisition alone. Note that the program according to the present embodiment includes information to be used for processing by an electronic computer and equivalent to the program (data which is not a direct command to the computer but has a property that regulates the processing of the computer and the like).

In addition, although the present device is configured by executing a predetermined program on the computer in this form, at least a part of the processing content may be implemented by hardware.

The present invention is not limited to the above-described embodiment, and appropriate changes can be made without departing from the spirit of the present invention.

1. A secure global model computation device in a federated learning system including K secure global model computation devices for training local models using training data,
wherein K is an integer of 3 or more, N is an integer satisfying 3≤N≤K, and arbitrary N secure global model computation devices among the K secure global model computation devices are able to constitute a secure global model computation system for performing secure computation of a global model from N local models, the secure global model computation device comprising:
a selection circuitry configured to transmit a query for checking an availability of computation resources to K−1 secure global model computation devices excluding the secure global model computation device itself and to select N−1 secure global model computation devices having a large availability of computation resources from the K−1 secure global model computation devices; and
a system configuration circuitry configured to configure a secure global model computation system using N secure global model computation devices obtained by combining the selected N−1 secure global model computation devices and the secure global model computation device itself.

2. A secure global model computation system configuration method for configuring a secure global model computation system by a federated learning system including K secure global model computation devices for training local models using training data,
wherein K is an integer of 3 or more, N is an integer satisfying 3≤N≤K, and arbitrary N secure global model computation devices among the K secure global model computation devices are able to constitute a secure global model computation system for performing secure computation of a global model from N local models, the secure global model computation system configuration method comprising:
a selection step in which one secure global model computation device (hereinafter referred to as a master secure global model computation device) among the K secure global model computation devices transmits a query for checking an availability of computation resources to K−1 secure global model computation devices excluding the master secure global model computation device itself and selects N−1 secure global model computation devices having a large availability of computation resources from the K−1 secure global model computation devices; and
a system configuration step in which the master secure global model computation device configures a secure global model computation system using N secure global model computation devices obtained by combining the selected N−1 secure global model computation devices and the master secure global model computation device itself.

3. A secure global model computation device in a federated learning system including K secure global model computation devices for training local models using training data,
wherein K is an integer of 3 or more, P is an integer of 2 or more, N is an integer satisfying 3<N<K/P, and arbitrary N secure global model computation devices among the K secure global model computation devices are able to constitute a secure global model computation system for performing secure computation of a global model from N local models, the secure global model computation device comprising:
a selection circuitry configured to transmit a query for checking an availability of computation resources to K-(p−1)N−1 secure global model computation devices excluding the secure global model computation device itself among K-(p−1)N secure global model computation devices (where p is an integer satisfying 1≤p<P) which are not selected for a secure global model computation system configuration and to select N−1 secure global model computation devices having a large availability of computation resources from the K-(p−1)N−1 secure global model computation devices;
a system configuration circuitry configured to configure a secure global model computation system (hereinafter referred to as a p-th secure global model computation system) using N secure global model computation devices obtained by combining the selected N−1 secure global model computation devices and the secure global model computation device itself; and
a local model training circuitry configured to train a local model using, as initial values of parameters of the local model, parameters of a global model of a p′-th secure global model computation system (where p′ is an integer satisfying σ(p′)=σ(p)−1) in one time of training among L times of training and parameters of a global model of the p-th secure global model computation system in the remaining (L−1) times of training among the L times of training if p is an integer satisfying σ(p)>1, and to train a local model using, as initial values of parameters of the local model, the parameters of the global model of the p-th secure global model computation system in the second and subsequent training if p is an integer satisfying σ(p)=1, wherein σ is a permutation of a set {1, . . . , P} and L is an integer of 2 or more.

4. A secure global model computation system configuration method for configuring a secure global model computation system by a federated learning system including K secure global model computation devices for training local models using training data,
wherein K is an integer of 3 or more, P is an integer of 2 or more, N is an integer satisfying 3≤N≤K/P, and arbitrary N secure global model computation devices among the K secure global model computation devices are able to constitute a secure global model computation system for performing secure computation of a global model from N local models, the secure global model computation system configuration method comprising:
a selection step in which one secure global model computation device (hereinafter referred to as a p-th master secure global model computation device) among K-(p−1)N secure global model computation devices (where p is an integer satisfying 1≤p≤P) which are not selected for a secure global model computation system configuration transmits a query for checking an availability of computation resources to K-(p−1)N−1 secure global model computation devices excluding the p-th master secure global model computation device itself, and selects N−1 secure global model computation devices having a large availability of computation resources from the K-(p−1)N−1 secure global model computation devices;
a system configuration step in which the p-th master secure global model computation device configures a secure global model computation system (hereinafter referred to as a p-th secure global model computation system) using N secure global model computation devices obtained by combining the selected N−1 secure global model computation devices and the p-th master secure global model computation device itself; and
a local model training step in which the p-th master secure global model computation device trains a local model using, as initial values of parameters of the local model, parameters of a global model of a p′-th secure global model computation system (where p′ is an integer satisfying σ(p′)=(p)−1) in one time of training among L times of training and parameters of a global model of the p-th secure global model computation system in the remaining (L−1) times of training among the L times of training if p is an integer satisfying σ(p)>1, and trains a local model using, as initial values of parameters of the local model, the parameters of the global model of the p-th secure global model computation system in the second and subsequent training if p is an integer satisfying σ(p)=1, wherein σ is a permutation of a set {1, . . . , P} and L is an integer of 2 or more.

5. A non-transitory computer-readable storage medium which stores a program for causing a computer to function as the secure global model computation device according to claim 1.

6. A non-transitory computer-readable storage medium which stores a program for causing a computer to function as the secure global model computation device according to claim 3.
